(19) United States
(12) Patent Application Publication
(10) Pub. No.: US 2004/0226393 A1
(43) Pub. Date: Nov. 18, 2004

(54) Crankshaft having a damper

(76) Inventor: Soon-Jae Hong, Gyeonggi-do (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/653,563

(22) Filed: Sep. 2, 2003

(30) Foreign Application Priority Data
Oct. 31, 2002 (KR) 2002-66944

(51) Int. Cl. F16H 21/48

(52) U.S. Cl. 74/68

(57) ABSTRACT

A crankshaft having a damper wherein torsional vibration occurring at the crankshaft can be effectively damped at various positions by a vibro-isolating rubber and an inertia arc integrally formed at a balance weight, thereby improving the damping of the torsional vibration of the crankshaft in comparison to a crankshaft formed with only one damper pulley.

### CROSS-REFERENCE TO RELATED APPLICATIONS

This application claims priority of Korean Application No. 10-2002-0066944, filed on Oct. 31, 2002, the disclosures of which are incorporated fully herein by reference.

### FIELD OF THE INVENTION

The present invention relates to a crankshaft of an engine. More particularly, the crankshaft includes a damper adapted to absorb torsional vibration generated from the crankshaft of an engine.

### BACKGROUND OF THE INVENTION

A conventional crankshaft is typically mounted at one side thereof with a flywheel and is equipped at the other side thereof with a damper pulley. The crankshaft is further mounted at a midsection thereof with a plurality of crank arms and crank pins for connecting to connecting rods. A balance weight is mounted on the opposite of where the crank pin of the crank arm is equipped.

The damper pulley principally transmits via a belt the turning force to auxiliary mechanisms, such as a water pump, an alternator, a power steering pump and the like where the turning force is provided from the crankshaft. In other words, the damper pulley including a hub, a vibro-isolating rubber and an inertia ring transmits the turning force to auxiliary mechanisms comprising a driven system, where the vibro-isolating rubber damps the torsional vibration generated from the crankshaft.

However, there is a drawback in the damper pulley thus constructed in that there is limited and restrictive space for mounting the vibro-isolating rubber for damping the torsional vibration. Only one vibro-isolating rubber can be accommodated therein, resulting in a lack of sufficient absorption of torsional vibration inevitably generated from the crankshaft. Insufficient damping of the torsional vibration created from the crankshaft can shorten the life of a belt and increase the vibration of an engine.

### SUMMARY OF THE INVENTION

Embodiments of the present invention provide a crankshaft having a damper constructed to more efficiently damp torsional vibration generated from the crankshaft at various areas. Preferably, a crankshaft having a damper comprises a vibro-isolating rubber mounted at a balance weight along a circumferential direction of the crankshaft and an inertia mass fixed at the balance weight via the vibro-isolating rubber.

In another preferred embodiment, a crankshaft comprises a crankshaft member with at least one balance weight mounted on the member. The balance weight preferably defines an arcuate groove therein. A resilient element lines the groove and an arcuate inertial mass is received in the resilient element in the groove. The resilient element preferably comprises a vibro-isolating rubber.

In a further preferred embodiment a crankshaft balance weight comprises a body member adapted to be mounted on the crankshaft and defining an arcuate groove spaced towards a periphery of the body member. A resilient element preferably lines the groove and an arcuate inertial mass is reived in the resilient element in the groove. The resilient element preferably comprises a vibro-isolating rubber.

### BRIEF DESCRIPTION OF THE DRAWINGS

For a fuller understanding of the nature and objects of the present invention, reference should be made to the following detailed description taken in conjunction with the accompanying drawings in which:

FIG. 1 is a schematic drawing illustrating an embodiment of a crankshaft having a damper according to an embodiment of the present invention; and

FIG. 2 is an exploded perspective view illustrating certain parts of a balance weight shown in FIG. 1.

### DETAILED DESCRIPTION OF THE INVENTION

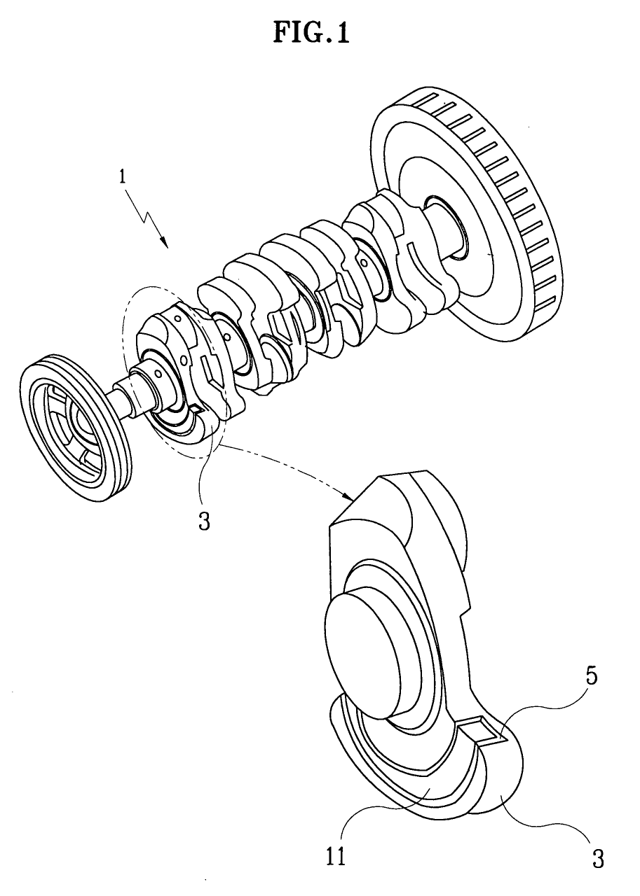

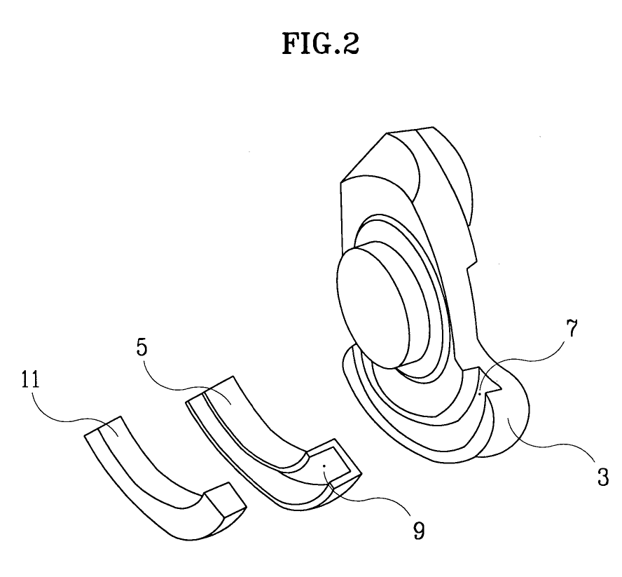

As shown in FIGS. 1 and 2, a crankshaft 1 according to an embodiment of the present invention includes an inertia mass formed at a balance weight 3 via a vibro-isolating rubber along the rotating direction of the crankshaft 1. That is, the balance weight 3 is mounted with a vibro-isolating rubber 5 along the circumferential direction of the crankshaft 1, wherein the inertia mass is fixed at the balance weight 3 via the vibro-isolating rubber 5.

The inertia mass and the vibro-isolating rubber 5 may be mounted at any balance weight 3 of the crankshaft 1, and may be installed in plural numbers, and may be appropriately adjusted in installation arrangements and positions thereof according to the engine.

Hereinafter, a detailed description will be given with regard to how the vibro-isolating rubber 5 and the inertia mass are preferably mounted at the balance weight 3.

The balance weight 3 is formed with a vibo-isolating rubber installation groove 7 of a predetermined cross-sectional shape along the circumferential direction of the crankshaft 1 in order to install therein the vibro-isolating rubber 5 and the inertia mass. The vibro-isolating rubber 5 is also formed with an inertia mass installation groove 9 of a predetermined cross-sectional shape along a circumferential direction of the crankshaft, where the inertia mass takes a form of an arc (inertia arc 11) having a predetermined cross-sectional shape along a circumferential direction of the crankshaft 1 so as to be inserted into the inertia mass installation groove 9.

As a result, the inertia arc 11 and the vibro-isolating rubber 5 can be embodied in the conventional balance weight without being changed in shapes to prevent interference with other existing operational elements.

Hereinafter, the operation of the present embodiment thus constructed will be described.

When the torque of the crankshaft 1 is changed by periodic firing of the engine, the inertia arc 11 connected to the crankshaft 1 by the vibro-isolating rubber 5 is rotated by a predetermined rotating inertia, which gives rise to a damping action of the torsional vibration generated from the crankshaft 1 via the vibro-isolating rubber 5.

Particularly, the inertia arc 11 and the vibro-isolating rubber 5 for restricting the generation of torsional vibration of the crankshaft 1 at the balance weight 3 can be installed at a plurality of balance weights 3, thereby enabling damping capability for attenuating the torsional vibration of the crankshaft 1 to a sufficient degree.

The crankshaft 1 equipped with the inertia arc 11 and the vibro-isolating rubber 5 at the balance weight 3 according to an embodiment of the present invention can be used with the conventional damper pulley to further improve an attenuating effect of the torsional vibration at the crankshaft 1.

As apparent from the foregoing, there is an advantage in the crankshaft having a damper according to an embodiment of the present invention thus described in that torsional vibration occurring at a crankshaft can be effectively damped at various positions by a vibro-isolating rubber and an inertia arc integrally formed at a balance weight, greatly improving the performance of damping the torsional vibration at the crankshaft in comparison to a crankshaft formed with only one damper pulley.

What is claimed is:

1. A crankshaft having a damper, the crankshaft comprising:
a vibro-isolating rubber mounted at a balance weight along a circumferential direction of said crankshaft; and
an inertia mass fixed at said balance weight via said vibro-isolating rubber.

2. The crankshaft as defined in claim 1, wherein said balance weight is formed with a vibro-isolating rubber installation groove of a predetermined cross-sectional shape along the circumferential direction of said crankshaft in order to install therein said vibro-isolating rubber and the inertia mass.

3. The crankshaft as defined in claim 2, wherein said vibro-isolating rubber is formed with an inertia mass installation groove of a predetermined cross-sectional shape along a circumferential direction of said crankshaft to install said inertia mass.

4. The crankshaft as defined in claim 3, wherein said inertia mass takes a form of an arc having a predetermined cross-sectional shape along a circumferential direction of said crankshaft so as to be inserted into said inertia mass installation groove.

5. A crankshaft comprising:
a crankshaft member;
at least one balance weight mounted on said member, the balance weight defining an arcuate groove therein;
a resilient element lining said groove; and
an arcuate inertial mass received in said resilient element in said groove.

6. The crankshaft of claim 5, wherein said resilient element comprises a vibro-isolating rubber.

7. A crankshaft balance weight, comprising:
a body member adapted to be mounted on a crankshaft and defining an arcuate groove spaced towards a periphery of said body member;
a resilient element lining said groove; and
an arcuate inertial mass received in said resilient element in said groove.

8. The crankshaft balance weight of claim 7, wherein said resilient element comprises a vibro-isolating rubber.
